(19) United States
(12) Patent Application Publication
(10) Pub. No.: US 2012/0201342 A1
(43) Pub. Date: Aug. 9, 2012

(54) NUCLEAR FUEL ASSEMBLY AND NUCLEAR REACTOR COMPRISING AT LEAST ONE SUCH ASSEMBLY

(75) Inventor: Thierry Jeanne, Venelles (FR)

(73) Assignee: Commissariat a l'energie atomique et aux energies alternatives, Paris (FR)

(21) Appl. No.: 13/500,770

(22) PCT Filed: Oct. 14, 2010
(86) PCT No.: PCT/EP10/65455

§ 371 Date: Apr. 6, 2012

(30) Foreign Application Priority Data
Oct. 16, 2009 (FR) 09 57283

(51) Int. Cl. G21C 3/322

(52) U.S. Cl. 376/443

(57) ABSTRACT

A nuclear fuel assembly including: a casing delimiting an inner space divided into a central part as a fissile zone, in which a bundle of nuclear fuel pins is located, an upper part, and a lower part; a lower end including a coolant supply inlet; an upper end including a coolant evacuation outlet; pins in a bundle of pins including an upper and/or a lower plenum; a mechanism creating a communication with the lower part of the inner space of the casing with the zone surrounding the assembly, as an inter-assembly zone, through the wall of the casing; and an upper neutron protection mechanism inside the casing.

### TECHNICAL FIELD AND PRIOR ART

This invention relates to an assembly for a nuclear reactor and a nuclear reactor comprising at least one such assembly, more particularly a Generation IV sodium-cooled fast neutron reactor also called GEN-IV Na-FNR.

In general, we continuously attempt to improve the operating safety of nuclear reactors and to limit propagation risks in case of accident.

A nuclear reactor comprises a confinement containment in which the reactor core is located, this core comprising adjacent fuel assemblies.

An assembly is cylindrical in shape, for example it may be hexagonal and it comprises a casing in which fuel pins are located. Each pin is composed of an envelope called the cladding inside which fuel pellets are stacked. The pin forms a sealed confinement for the pellets. The cladding and the casing are metallic. The pin comprises three main zones: a central zone called the fissile zone in which the fuel is located, an upper zone possibly comprising an upper plenum and a lower zone possibly comprising a lower plenum.

A pin comprises a lower plenum and/or an upper plenum, the plenum(s) is (are) necessary to absorb the formation of fission products generated in the long term in the fissile zone. If there were no plenum, the generation of fission products would deform the cladding in the fissile zone and therefore compromise circulation of the coolant.

A coolant circulates between the pins in each assembly to evacuate thermal energy generated by the fuel. This energy is then converted into electrical energy. In the case of GEN-IV Na-FNRs, the coolant is molten sodium. The coolant extracts heat to convert it and consequently cools the assembly, preventing it from overheating.

The coolant circulates in a closed circuit upwards from the bottom of the assembly by means of pumps. One or several heat exchangers are provided at the exit from the assembly to extract calories from the coolant.

One of the envisaged accidents is a thermal meltdown of one or several assemblies for example due to a cooling problem, and then extension of this degradation to the entire active core. An attempt is made to prevent propagation of this meltdown to the entire active core, i.e. to adjacent assemblies that could cause destruction of the reactor envelope, or possibly the reactor confinement containment.

This accident scenario comprises three phases:
a primary phase during which an internal core fuel assembly degradation mechanism occurs, this degradation occurring due to melting of the cladding, collapse of the pellets, and extension of the cavity on the fissile zone of the assemblies.

This melting of one or several assemblies quickly causes the formation of baths of boiling liquid corium confined in more or less sealed cavities, with relocations of the molten materials towards the upper and lower parts of the assembly.

Corium is defined as being a mass of fuel and structural elements of the core of a molten nuclear reactor mixed together than can form in the case of an accident,
a transition phase with lateral propagation of corium that occurs due to melting of the assembly casings, thus propagating melting to adjacent assemblies. This is called a “contamination” mechanism between assemblies,
a secondary phase, when this contamination extends to all fissile assemblies of the core, with the formation of a widespread bath.

During this accident phase, the compaction and re-compaction of the fissile material can lead to high energy power excursions that can eventually compromise the mechanical behaviour of the reactor vessel.

There may be several causes of the initiation of an assembly fusion, for example:
there may be a failure in the sodium supply to assemblies. This can happen generally, with the loss of primary pumps circulating sodium in the assemblies without the control rods dropping; or it may be local, with a supply defect in one assembly (this accident is called the local Total Instantaneous Blockage or more simply TIB accident),
there can be an abnormal increase in temperature in the assembly but with normal operation of the primary pumps, for example by unwanted withdrawal of the control rods, loss of secondary cooling, or passage of gas bubbles in the core.

In the case of a supply fault, sodium vaporisation initiates over the entire fissile height and the cladding is dried, the cladding then melts characterised mainly by a vertical columnar flow of the steel that freezes as soon as it comes into contact with colder structures. The accumulation of this “frozen” steel very quickly forms a dense metal crucible. The mobility of this crucible then depends on successive melting of the cladding until it reaches the bottom of the fissile column. A partial upper plug is formed during this so-called “decladding” phase. This originates from interaction phenomena between the molten steel and sodium, and upwards entrainment of the molten steel by the sodium vapour. This plug then moves along the upper melting front of the cladding.

Conversely, in the case of an abnormal temperature increase, the sodium supply of the assemblies is not interrupted, with the result that interaction phenomena between molten steel and sodium are stronger and more continuous.

The mechanism for upwards entrainment of molten steel by sodium vapour is then more efficient.

The progressive formation of this upper plug reduces the sodium supply to the assembly until it is eventually eliminated because the sodium can no longer escape upwards, or it is more difficult to do so.

The pressure in the zone under the upper plug then tends to reach values comparable with the primary pump lifting pressure.

The assembly is then drained from the bottom.

In the remainder of the scenario, the collapse of fuel pellets tends to form a cavity which extends in the axial direction progressively covering the height of the fissile column. The collection of fuel debris near the bottom of the fissile column associated with a part of the molten steel from the cladding causes formation of the lower plug. The corium flow cannot be controlled.

Such a behaviour can eventually compromise the mechanical behaviour of the reactor vessel. It can also compromise the mechanical behaviour of the reactor unit confinement containment.

The problem that then arises is to control the corium flow.

Therefore, the purpose of this invention is to disclose a safer reactor and assembly structure so that radial propagation of the corium can be limited if an incident occurs, to encourage the corium flow towards the bottom of the reactor and to reduce risks of criticality.

### PRESENTATION OF THE INVENTION

The previously mentioned purpose is achieved by a nuclear fuel assembly comprising means of limiting the rise of corium in the assembly and preventing its accumulation at the fissile zone, thus reducing risks of radial propagation of corium while allowing sodium circulation through a part of the assembly, even in a degraded manner.

This is done by encouraging the formation of a plug in the upper part of the assembly above the fissile zone, and enabling communication between the inside of the assembly and the inter-assembly zones in the lower part of the assembly.

The formation of an upper plug above the fissile column limits the rise of corium in the assembly.

Creating a communication between the inside of the assembly and inter-assembly zones enables evacuation of the coolant, which limits the risks of corium rising under the action of the pressurised coolant. Furthermore, this created communication enables the coolant to continue to circulate along the assembly and outside it, and to evacuate heat from the melting zone.

In a particularly advantageous manner, evacuation of corium downwards in the assembly is also facilitated to take corium away from the fissile zone of the assemblies, to take this molten material away from adjacent assemblies and prevent the propagation of corium into adjacent assemblies. This is done by weakening the lower zones of the pins. The means used are passive and do not require any external control.

This particularly advantageous embodiment improves control over the downwards movement of corium inside each fuel assembly in an accident situation.

Weakening of the lower part of the pins can facilitate the downwards propagation of corium. The downwards movement of corium is advantageously encouraged by eliminating the presence of materials with high inertias, for example by eliminating the lower axial blanket or “LAB”, (i.e. the presence of fertile pellets near the bottom of the bundle of pins).

In another example, the lower neutron protection in the bundle of pins is eliminated because it could make corium on the walls freeze, which could prevent corium from moving downwards.

In yet another example, the diameter of the lower ends of the pins is reduced to limit the quantity of material and in an accident situation to facilitate the accumulation of molten materials.

The invention prevents local degradation from spreading in the radial direction in the case of severe core meltdown accidents; change from the primary phase to the transition phase, towards the formation of a generalised corium bath confined in an extended cavity over the active part of the core.

This thus prevents occurrence of the secondary phase during which risks of compaction/re-compaction of the fissile material cannot be excluded.

This prevents compromising the mechanical behaviour of the reactor vessel and even the reactor unit confinement containment that can occur during a case of criticality/re-criticality, associated power excursions may then be very high energy.

Advantageously, when melting has begun in an assembly, melting in the downwards axial direction is encouraged so as to facilitate evacuation of corium away from fissile zones of other assemblies and prevent propagation of corium in the radial direction.

This is done by facilitating freezing of the corium in the upper part of the casing, weakening the lower structures to facilitate downwards movement of the corium and to reduce risks of formation of the lower plug.

Advantageously, a recuperator associated with each assembly is provided in the lower zone of the assembly to recover corium. The recuperator can reduce the risk of criticality. Advantageously, this recuperator may comprise a neutron absorbing material.

The subject-matter of this invention is mainly a nuclear fuel assembly comprising:
a casing delimiting an inner space divided into a central part called the fissile zone in which a bundle of nuclear fuel pins is located, an upper part and a lower part,
a lower end comprising a coolant supply inlet,
an upper end comprising a coolant evacuation outlet,
pins in the bundle of pins comprising an upper and/or a lower plenum,
means of creating a communication with the lower part of the inner space of the casing with the zone surrounding the assembly, called the inter-assembly zone through the wall of the casing, and
upper neutron protection means arranged inside the casing, called the internal upper neutron protection means.

Advantageously, at least one of the pins does not contain any fertile material at its lower end.

Also advantageously, the lower end of at least one of the pins has a smaller diameter than the outside diameter of the other parts of said pin.

It may be possible that at least the lower end of at least one pin is made of metal with a low melting point, lower than the temperature of the corium or of a metal alloy for which the phase diagram has eutectic or peritectic points at an equivalent temperature lower than the corium temperature.

In one example embodiment, at least one of the pins comprises only an upper plenum.

At least one of the pins might not have any lower neutron protection. Advantageously, not all pins comprise any lower neutron protection, and the lower neutron protection is integrated into the casing.

The lower part of the casing may have an inside diameter less than the diameter of the fissile zone and it may be surrounded by a thicker casing wall than the wall surrounding the fissile zone, thus forming a lower neutron protection.

The means of creating a communication between the lower part of the inner space of the casing and the inter-assembly zone for example comprise channels passing through the wall of the casing surrounding the lower part and means of closing off channels below a given pressure threshold in the lower part. For example, the closing means may be formed from rupture disks, exhaust valves or non-return valves.

The internal upper neutron protection means may be formed by the upper part of the casing comprising an inside diameter smaller than the diameter of the fissile zone and being surrounded by a casing wall thicker than the wall surrounding the fissile zone.

In one example embodiment, the internal upper neutron protection means are integrated into the pins and form the upper end of the pins.

In another example embodiment, the internal upper neutron protection means are arranged above the pins and in line with them.

A fertile material may be fixed to the internal upper neutron protection means and be placed between each pin and the associated internal neutron protection means.

The casing advantageously comprises projections on its outer face that will come into contact with the faces of the other casings surrounding it to form spacers. Said projections are preferably arranged approximately at the fissile zone.

For example, the casing has a polygonal section, the external vertices advantageously being truncated and/or provided with a groove extending over at least part of the height of the casing.

The subject-matter of this invention is also a set of assemblies according to this invention and a corium recuperator.

For example, the corium recuperator may be in the form of a jar that will collect corium flowing from inside the casing.

In one embodiment, the corium recuperator fits into a housing in the casing between the coolant supply and the fissile zone.

The cross-section of the passage between the inner face of the recuperator housing and the outer face of the recuperator may for example be approximately equal to the cross-section of the assembly coolant supply inlet passage.

In one advantageous example, the recuperator can pass from a high position in which the coolant flow passage between the supply inlet and the supply outlet is open, to a low position in which the coolant flow passage between the supply inlet and the supply outlet is closed. The corium recuperator can be held in the high position by an elastic means or by fusible support tabs.

In another embodiment, the corium recuperator is arranged below the casing. For example, said corium recuperator may be fixed to the assembly or it may be supported by a diagrid located below a diagrid supporting the assembly.

Advantageously, the corium recuperator comprises a neutron absorbing material.

Another subject-matter of this invention is a nuclear reactor comprising a plurality of assemblies, at least one of which complies with this invention, arranged adjacent to each other and delimiting inter-assembly zones between them, and coolant circulation pumps in the assemblies.

Another subject-matter of this invention is a nuclear reactor comprising a plurality of assemblies, including at least one set according to this invention arranged adjacent to each other and delimiting inter-assembly zones between them, and coolant circulation pumps in the assemblies.

For example, the nuclear reactor is a liquid sodium-cooled reactor.

### BRIEF DESCRIPTION OF THE DRAWINGS

This invention will be better understood after reading the following description and the appended drawings in which:

FIG. 1 shows a diagrammatic longitudinal sectional view of one example embodiment of a fuel assembly according to this invention,

FIGS. 2A to 2D show example embodiments of fuel pins according to the invention,

FIG. 3 is a longitudinal sectional view of several assemblies according to this invention in a primary accident phase,

FIG. 4 is a cross-sectional view of a set of assemblies according to the invention,

FIG. 5 shows a longitudinal sectional view of another example of an assembly according to this invention provided with a corium recuperator integrated inside the assembly,

FIG. 6 shows an example embodiment of a corium recuperator according to the invention,

FIGS. 7A-7B and 8A-8B are views of two example embodiments of an assembly according to this invention comprising corium recuperators according to the invention integrated into the assemblies and also forming passive corium confinement systems inside the assembly casings,

FIG. 9 shows a longitudinal sectional view of an example of an assembly comprising an assembly and a recuperator arranged under the assembly and fixed to it according to this invention,

FIG. 10 shows a longitudinal sectional view of another example assembly comprising an assembly and a recuperator arranged under the assembly but not fixed to it according to this invention.

### DETAILED PRESENTATION OF PARTICULAR EMBODIMENTS

In this description, the term “pin” refers to a fuel rod comprising at least one fissile material used especially in fast neutron reactors.

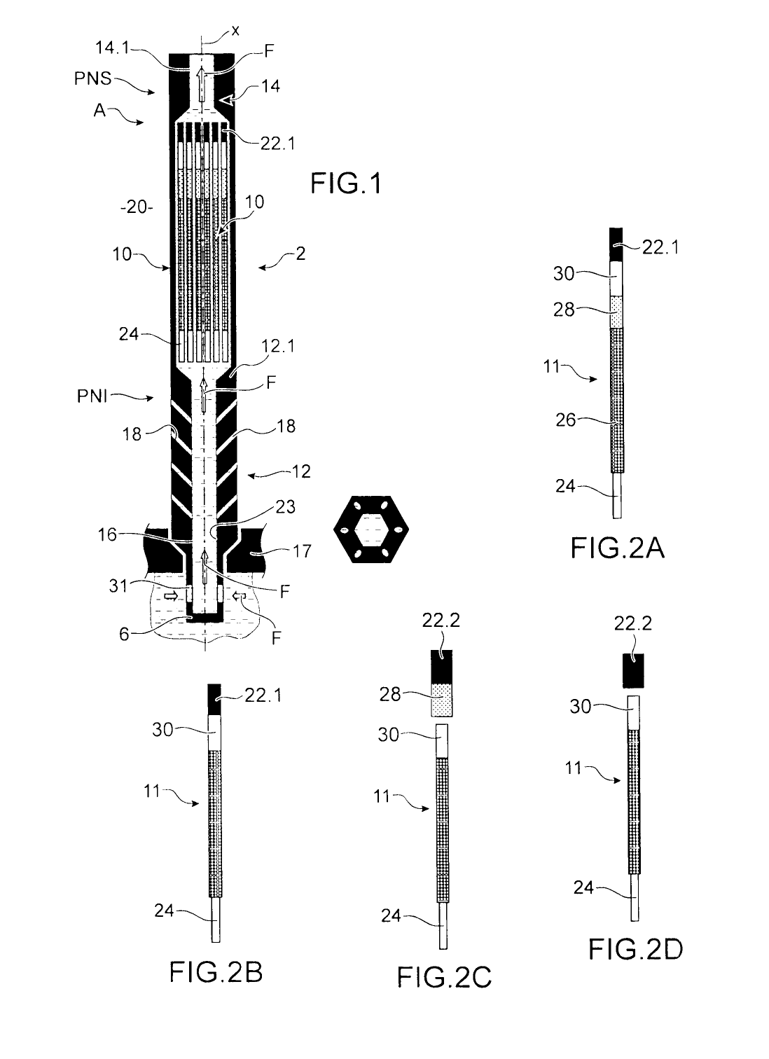

FIG. 1 shows an example embodiment of an assembly A according to this invention, comprising a casing 2, and fuel pins arranged inside the casing 2.

In the example shown, the casing 2 is cylindrical in shape and has an hexagonal cross-section with its X-axis that can be arranged vertically as is shown in FIG. 1.

Obviously, an assembly for which the casing is cylindrical in shape and that has a circular section would not be outside the scope of this invention.

The casing 2 comprises a first lower end 6 through which coolant penetrates and an upper end 8 through which coolant is evacuated.

The coolant circulates continuously in a closed circuit (not shown) under the action of pumps (not shown) called the primary pumps. The coolant circulation is shown diagrammatically by the arrows F.

For example in an Na-FNR, the coolant may be liquid sodium. However, the assembly according to this invention can be used with other coolants, for example pure bodies such as sulphur (S), lithium (Li), selenium (Se), tin (Sn), bismuth (Bi), lead (Pb), gallium (Ga) and indium (In), binary or ternary alloys comprising at least one of the pure bodies mentioned above including sodium (Na) [for example lead bismuth (Pb—Bi), lead-potassium (Pb—K), lead manganese (Pb—Mg), lead sodium (Pb—Na), sodium potassium (Na—K), and lead bismuth lithium (Pb—Bi—Li)] and molten salts (with composition containing one of the pure bodies mentioned above including sodium) [for example Li₂BeF₄, NaF—ZrF₄, LiF—NaF-KF, LiF—RbF, LiF—BeF₂, NaF—BeF₂, NaF—ZrF₄, NaF-KF—ZrF₄, NaF—NaBF₄, RbF—PbBF₄ and NaBF₄]. Other molten salts such as KF—KBF₄, NBF₄ or RbF₄ could be envisaged.

The casing 2 delimits an inner space divided into a central part 10 or a fissile part containing a bundle of pins 11, a lower part 12 between the lower end 12 and the central part 10, and an upper part 14 between the central part 10 and the upper end 8.

In the example shown, the inner cross-sectional part of the central part 10 is larger than the inner cross-sections of the lower 12 and upper 14 parts. On the other hand, the outer cross-section of the casing is approximately constant over its entire height, except at a lower end. Consequently, the walls 12.1, 14.1 of the lower 12 and upper 14 parts are thicker than the wall surrounding the fissile zone 10. These variations in the wall thickness form neutron protections for the upper casing PNS and for the lower casing LNP respectively.

The assembly A is mounted on its lower end, called the assembly stand 16, in a support 17 called the diagrid in which the other assemblies are also mounted.

The assembly stand 16 is formed by a portion of the casing 2 with a reduced outside diameter.

According to this invention, the assembly casing 2 comprises channels 18 in the wall 12.1 of the lower part 12 of the casing, these channels 18 being designed to connect the inner volume of the assembly A to the outer volume 20 of the assembly, called the inter-assembly zone.

During normal operation, these channels 18 are closed and will only open when the coolant pressure exceeds a given pressure threshold.

Therefore passive closing means (not shown) are provided in the channels 18. They may be non-return valves, exhaust valves or rupture disks that break above a given pressure.

The passive nature assures that channels open without any external order.

Note that melting of an assembly can begin even if it is not detected immediately. Consequently autonomous operation of safety means is desirable, particularly means of mitigating melting an assembly.

The channels 18 are advantageously distributed around the entire periphery of the envelope of the casing and over the entire height of the lower part of the casing, so that they enable homogeneous evacuation of the coolant towards the inter-assembly zone 20.

Furthermore, the channels 18 are advantageously inclined relative to the X-axis in the coolant circulation direction, this orientation facilitating the flow towards the inter-assembly zone 20.

Furthermore, the diameter of the channels is advantageously chosen to be approximately equal to the distance between two casings in the inter-assembly zone 20.

As an example, we will determine a number of channels 18 adapted to degraded operation of the reactor.

Globally and for all Na-FNRs, sodium enters through the bottom of the assembly at about 400° C. and then exits at 550° C. after being heated by the fuel. Its temperature rise along the fissile column is about 150° C.

This temperature is about 330° C. from its boiling point at the ambient pressure above the fuel pin bundle, because the sodium should not boil.

In this case, the ambient pressure takes account of the weight of the sodium column and the pressure in the cover-gas plenum. The reactor roof is the free volume located in the upper part of the vessel composed of a neutral incondensable gas capable of absorbing thermal expansions of the vessel during normal, incident and accident operations; its pressure during normal operation is of the order of 1 bar.

If a supply defect of 10% per assembly is tolerated during nominal operation, corresponding to the sodium flow that can be transferred into inter-assembly spaces if the intra-inter assembly communication channels 18 should be opened accidentally and to sodium flow inside the assembly towards the inter-assembly zone at constant power, the temperature rise of the sodium along the fissile column will increase by 10%. For the characteristics mentioned above, this increase corresponds to the sodium outlet temperature of 165° C. Under these conditions, the margin to the boiling point is reduced to 315° C. Therefore, the temperature is closer to the temperature at which sodium starts to boil. However, this margin is still sufficiently high to prevent boiling. As a first approximation, if it is assumed that flows are proportional to the passage cross-section (neglecting fluid/structure friction and pressure losses at geometric singularities), the required number of holes would be about 30 to 40 for an assembly for which geometric characteristics are similar to those defined in the PHENIX reactor. The diameter of the holes is then of the order of 3 mm.

Flow from the inside of casing 2 towards the outside is possible because the pressure in the inter-assembly zone 20 is less than the pressure of the coolant in the lower part of the casing. The coolant in the inter-assembly zone does not circulate under a normal situation; its pressure is only the hydrostatic pressure of the column of coolant in the reactor unit plus the pressure at the reactor roof.

This flow is much easier than a coolant flow towards the bottom of the assembly, particularly due to pressure losses at the bottom of the assembly and the pressure output by the pumps at the casing inlet.

The ratio between the coolant flow in the intra-assembly zones and in the inter-assembly zones is fixed as a function of the characteristics of the core, assemblies and pins and as a function of the different degradation rates specific to each type of accident. This ratio also depends on:
the number of communication holes in the lower part of the casings and their hydraulic diameter,
passive systems for creating a communication, particularly the pressure loss that they induce, the opening time, etc., and the pressure difference beyond which passages are open to enable flow.

Circulation of coolant between assemblies A has several advantages, apart from the pressure reduction in the lower part of the casing 2.

Firstly, the coolant transferred between the assemblies is cold because it is located in the zone on the upstream side of the fissile zone 10.

Therefore, it also forms means of cooling the outer faces of the casings 2 by circulation in the inter-assembly spaces. Therefore it participates in delaying thermal melting of the casings.

Secondly, circulation of the coolant between the inside and outside of the assembly(ies) enables faster detection of an incident.

The coolant in the casing contains fission products brought by the corium moving downwards.

As it moves upwards in the inter-assembly channels, the coolant carries these products upwards towards the delayed neutron signal detectors.

According to this invention, at least part of the upper neutron protection means will be formed inside the casing, in the pins and/or in the casing, the protection means being arranged above the pins at a distance from them as described above, by making a section with a smaller diameter, the protection provided by these means being in addition to the protection already provided by the extra thickness at the upper part 14.1 of the casing 2 as explained above.

FIGS. 2A to 2D show example embodiments of these protection means, called internal upper neutron protection means.

FIG. 2A shows internal upper neutron protection means 22.1 directly integrated into the pin 11 and forming an upper longitudinal end of the pin, oriented towards the downstream side of the fissile zone. In this example, the pin comprises a lower plenum 24, a fissile material 26, fertile material 28, an upper plenum 30 and internal upper neutron protection 22.1, in order from the bottom upwards.

FIG. 2B shows internal upper neutron protection means 22.1 that also form the upper end of the pin, however the pin does not contain any fertile material (called “upper axial blanket” or “UAB”).

There is no need for the fertile material to be located in the pins. The fertile material may be arranged either around the periphery of the core, contained in the assemblies forming the outer edges of the core which is called the radial blanket, in this case the internal assemblies do not necessarily contain any fertile material, or it may be located in the upper and/or lower parts of the fuel assemblies (the term axial blankets is used) as in the case of the assembly shown in FIG. 2A.

The fertile material changes throughout the life of the reactor, so that fertile isotopes can be transmuted into fissile isotopes.

In FIGS. 2C and 2D, the internal upper neutron protection means 22.2 are separated from the pin and are arranged above it and in line with it. In FIG. 2C, the internal upper neutron protection means 22.2 are associated with the fertile material and in FIG. 2D, the internal upper neutron protection means are alone.

In the variants shown in FIGS. 2C and 2D, the assembly comprises a bundle of pins and a protection bundle, each element of the protection bundle being approximately in line with a pin 11.

Therefore, protections 22.2 are formed by a second type of pins with different geometric characteristics from the main bundle of pins. The position in the assembly may for example be formed by support grids.

The internal upper neutron protection means 22.1, 22.2, for example in the form of a solid cylinder or having a small diameter central hole, are not outside the scope of this invention.

The internal upper neutron protection means 22.1, 22.2 may for example be made from the same steel as the pin cladding.

This displacement of part of the upper neutron protection means at the pin bundle encourages the formation of a dense upper plug above the fissile zone 10 when an accident occurs. If these protection means 22.1, 22.2 are made of steel, which is a material that has a good thermal inertia and good thermal conductivity, the corium can be frozen over small heights, stopping its upwards movement. Displacement of the protection means and the fact that they are made individually is particularly efficient because the protection means 22.1, 22.2 have a large exchange area with corium, proportional to the number and diameter of pins contained in the bundle.

Furthermore, since the protection means 22.1, 22.2 act as neutron reflectors, they reduce the height of the upper neutron protection at the upper end of the casing at least proportionally. Furthermore, the neutron protection means 22.1, 22.2 in the bundle are more uniformly distributed in the casing and are therefore more efficient against neutron leaks than the protection formed by the casing.

Obviously, the upper neutron protection structures formed from a combination of the pins in FIGS. 2A to 2D are not outside the scope of this invention. For example, protection may be provided inside the pin and also above the pin.

Furthermore advantageously, the lower end of the pins is modified so as to eliminate or at least reduce cold zones that might slow downwards movements of the corium by freezing of the corium and it is also made fusible to facilitate its fusion and facilitate the downwards movement of the corium.

FIGS. 2A to 2D, also show an example embodiment of the lower end of the pin according to this invention.

In one particularly advantageous embodiment, the presence of a lower fertile material at the lower end of the pin, also called the lower axial blanket, is reduced or even excluded.

The lower fertile material may be missing from all pins in the assembly, or only in some of the pins. Therefore, the total or partial absence of a lower fertile material reduces the presence of materials in the lower part of the pin bundle, and therefore the presence of a mass creating a risk of the corium freezing.

A reactor core according to one advantageous embodiment of this invention may comprise a plurality of assemblies according to this invention, and different assemblies could be provided depending on whether or not the lower fertile material is present.

In one advantageous example, it would be possible to exclude the presence of a lower neutron protection at the lower end of the pins. This can apply to all pins or only some of the pins.

The advantages related to eliminating this protection are similar to the advantages mentioned due to total or partial elimination of the lower axial blanket.

The lower neutron protection (PNI) is then advantageously integrated into the casing as is shown by the overthickness of the wall of the casing 2, as described above. Therefore the quantity of structures at the lower end of the pin is very much reduced.

Therefore, the risks of freezing of molten materials due to the thermal inertia of these materials are reduced. The molten materials can flow downwards more easily.

The height of the lower part of the casing forming the lower neutron protection PNI chosen as a function of the reflection power that is to be obtained.

Furthermore, the hydraulic diameter of the channel 23 in the lower part 12 of the casing is advantageously approximately equal to the hydraulic diameter of the coolant supply windows 31 formed in the bottom of the assembly 16. The windows 31 are shown at the side in the example shown.

This diameter allows all downwards corium movements without causing any blockage due to freezing of the corium or jamming of corium debris. The downwards movement of corium takes place mainly in packets and it freezes in mass on contact with sodium to form debris.

Furthermore, this debris can break suddenly as it cools (change in the liquid/solid density) and form smaller debris for which the diameter remains small compared with the cross-sectional passage at the lower neutron protections (PNI) in the casing.

Furthermore, advantageously, the fusibility of the lower end of the cladding of the pins 11 can be improved, i.e. melting of the cladding can be encouraged to facilitate downwards movement of the corium. The metal or metal alloy forming the lower end of the cladding of the pin is advantageously chosen to provide either a thinner cladding to have a lower thermal inertia, or a lower melting point (solidus temperature), or having eutectic or peritectic points at low temperatures in its phase diagram, lower than the temperature of the other materials forming the other parts of the cladding of the pins if applicable, so as to have less resistance to movement of the corium.

The fusibility temperature required for the region of the lower plenum cladding is of the order of 1300 K.

In FIGS. 2A to 2D, the pin have a lower plenum 24. It is then planned to weaken the lower plenum, so as to make it easier to melt. The figures show an example embodiment of the lower plenum 24 in this invention. Its outside diameter is less than the diameter of the cladding of the pin in the fissile zone and the upper plenum 30, while keeping exactly the same cladding thickness. This reduction in the diameter, apart from the fact that it reduces the quantity of material to be melted, can increase the cross-sectional passage of the coolant between the pins at the lower plenums 24. The result is that when the molten material formed by the cladding and the pellets from the fissile zone reaches the lower plenums, a greater mass of molten materials can be trapped around the cladding of the lower plenums. Consequently, the thermal energy around the cladding of the lower plenums is greater, which encourages melting of the lower plenum cladding.

For example, the outside diameter of the pins at the lower plenums may be 10% to 40% lower than the diameter defined in the fissile zone of the pins.

In one example embodiment, all the pins or only some of the pins do not have a lower plenum.

The quantity of material to be melted and that can form an obstacle to the progress of the corium becomes null if there is no lower plenum and no other structure such as the lower neutron protection and the lower axial blanket.

Advantageously, pins can be made for which the cladding is formed of several materials. For example, a first material can be chosen for the cladding of pins in the fissile and upper parts, and a second material could be chosen for the lower part covering the lower end of the pin, for example forming the lower plenum. The fact of having a material at the lower end of the pins for which melting occurs at a lower temperature than the upper part of the pin does not create a problem during normal operation because this material is located in a cold region, which gives a large margin against melting during normal operation.

Furthermore, the facilitated separation of the lower plenums means that the support grid (not shown) in which the lower plenums of a bundle of pins are mounted just under the fissile zone 10, can be separated at the same time. Separation of this structure releases the passage cross-section of the casing, facilitating downwards propagation of the corium.

Furthermore, the cylindrical geometry of the lower plenums further encourages their melting or thermal weakening.

During fusion/collapse of the first row of pellets at the bottom of the fissile zone 10, corium can penetrate inside these tubes and therefore melt them more quickly or it may make them less resistant to temperature.

Advantageously, spacers 34 shown in figure are provided between the assemblies A and particularly between the casings 2 that will keep the inter-assembly channels open, regardless of the operating conditions. The spacers 34 further encourage downwards movement of the corium. The inter-assembly channels 20 enable circulation of the coolant through the escape channels 18, when they are open in an accident situation, which facilitates downwards movement of the corium.

Preferably, the spacers 34 are arranged at fissile zones 10 of the assemblies A, at the location at which radial swelling of the casing is greatest. These spacers prevent or at least reduce risks of closing off the inter-assembly channels.

The shape and dimensions of the spacers 34 are chosen as a function of the required coolant flow.

Note that these spacers 34 do not disturb normal operation of the reactor, because coolant does not circulate between the assemblies during normal operation.

Also advantageously, and as can be seen in FIG. 4, the outer summits 36 of the casings 2 can be truncated to assure the presence of an inter-assembly channel even in the case of radial swelling.

If the three casings 2 defining a channel are in contact in pairs through their outer faces, there will be a residual inter-assembly channel.

Even more advantageously and as shown, recessed grooves are formed in the corners over the entire length of the fissile zone of the casings, which delimits a larger cross-section channel.

Obviously, spacers may be added and/or the corners of the casings may be truncated.

The characteristics of the pins according to the invention described above may apply to all pins in the assembly bundle or only some of them. Consequently, the pins in a single assembly are not necessarily identical in shape and composition.

Advantageously, the assembly according to this invention may also comprise an individual corium recuperator located inside the casing at a lower end of the assembly or below it.

The reactor according to this invention comprises a plurality of recuperators each associated with an assembly, each recuperator then being designed to recuperate corium from the assembly with which it is associated.

The recuperator, also called the ashtray, is in the form of a jar and it will recuperate all or some of the corium originating from internal degradation of the assembly.

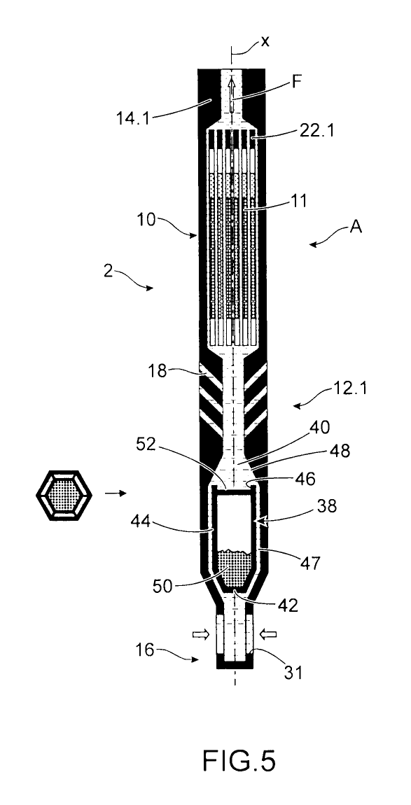

FIG. 5 shows an example embodiment of an assembly provided with a corium recuperator 38 integrated inside the assembly.

In this example embodiment, the recuperator 38 is housed in the casing 2 between the assembly bottom 7 provided with coolant supply windows 31 and the zone provided with escape conduits 18.

The casing 2 comprises a housing 40 located between the lower neutron protection and the inlet end of the coolant.

The recuperator 38 is fixed in the housing 40, for example by means of attachment tabs (not shown), the arrangement and shape of which minimise their action on the coolant flow.

The recuperator 38 is in the form of a jar, the shape of the section of the jar being approximately the same as the section of the casing, i.e. hexagonal or circular. Therefore, the jar comprises a bottom 42, a sidewall 44 and an upper end 46 through which corium will penetrate into the jar.

The passage section 47 between the wall 44 of the recuperator and the wall of the housing 40 of the casing 2 is advantageously sized such that it corresponds to the upstream and downstream walls of the housing 40, in order to limit disturbances to normal operation of the reactor.

Advantageously, the bottom 42 of the jar has a tapered profile, and the part of the corresponding housing 40 is also tapered in order to limit pressure losses.

Also advantageously, the connection 48 between the housing 40 and the zone in which conduits are formed comprises sidewalls inclined in the direction of the X-axis, reducing pressure losses and directing the coolant towards the exit from the housing 40.

The height of the recuperator 38 and therefore its volume are chosen as a function of the quantity of corium that can form during degradation of the assembly, and the thickness of the recuperator 38 is determined to retain this corium mass.

The quantity of corium that can be contained in the recuperator depends on neutron aspects, to make sure that the mass of corium contained in the recuperator cannot be become critical for any of the design accident scenarios.

It is also advantageous to encourage cooling of corium after the accident. For example, this can be done by providing fins (not shown) on the outer surface of the recuperator 38, which increases heat exchanges with the coolant.

Also advantageously, a material with a given porosity is used to make the recuperator 38 to enable circulation of coolant vapour from the outside of the casing towards the inside. However this porosity is such that it does not modify the confinement of the corium.

Preferably, the recuperator comprises a neutron absorbing material 50, which can reduce or even eliminate risks of criticality.

For example, this material may be arranged in the bottom of the recuperator as shown in FIG. 5, for example in the form of balls or a powder.

Advantageously, the recuperator containing a neutron absorbing material 50 may comprise a lid 52 closing off the recuperator inlet as shown in FIG. 5. This lid 52 can melt and will not hinder inlet of the corium.

This lid can prevent upwards movements of neutron absorbing material by flow of the coolant towards the assembly, which can form local plugs between the pins and can cause deterioration of cooling that could cause local melting.

The lid can be replaced by a filter or grid type element. If grids are used, the holes in the grids shall be chosen to be sufficiently small compared with the triangular pitch of the pins. If entrainment occurs, this prevents a piece of neutron absorbing material from getting trapped mainly in the pin bundle, particularly in the fissile zone and generate a local cooling defect that could cause a degradation mechanism, i.e. the formation of a hot point, a mechanical or thermal rupture of the cladding, etc.

If the recuperator opening is closed off by a lid 52, the inside volume of the recuperator will be filled with an incondensable inert gas that may be identical to the gas used in the pin plenum(s), the pressure of which is the same as the hydraulic pressure of the coolant at the inlet to the casing, so as to prevent untimely rupture of the lid 52.

During normal operation, the temperature of the gas is the same as the temperature of the cold sodium at the assembly inlet. If it is assumed that the pressure follows the perfect gas law (PV=nRT), then the gas pressure only depends on the number of moles “n” introduced into the volume of the recuperator at the time that it is used (namely a transformation at constant P/T). Therefore the pressure can be determined simply to prevent untimely failure during normal operation of the reactor under the effect of gas expansion due to temperature rise.

The neutron absorbing material can be made in the form of cladding covering the inner face of the recuperator wall. This cladding is covered with a metal envelope.

This cladding and this envelope also form a barrier that delays melting. Furthermore, this cladding does not hinder the flow of corium debris in the recuperator.

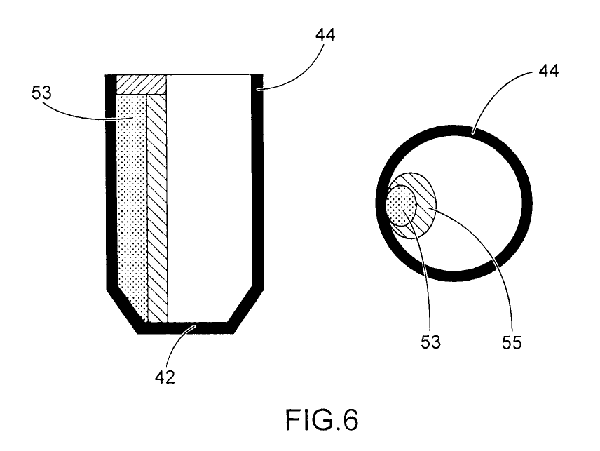

The neutron absorbing material could be made to cover the entire height of the recuperator, for example in the form of a bar 53 as shown in FIG. 6. The material then fits inside a cylindrical envelope 55.

With this embodiment, there is no need to close the recuperator.

This embodiment has the advantage of distributing the neutron absorbing material uniformly over the entire height of the recuperator.

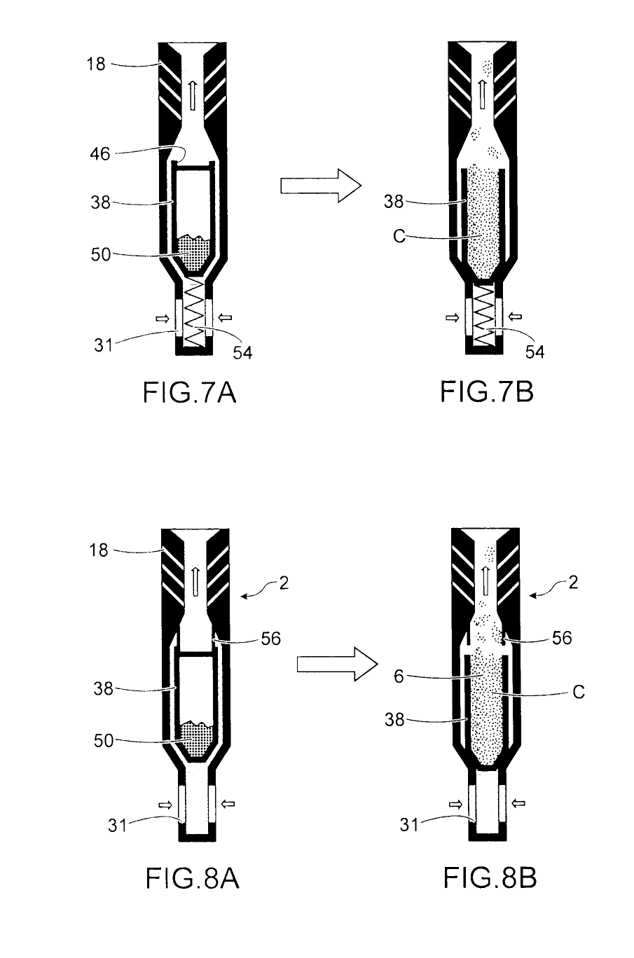

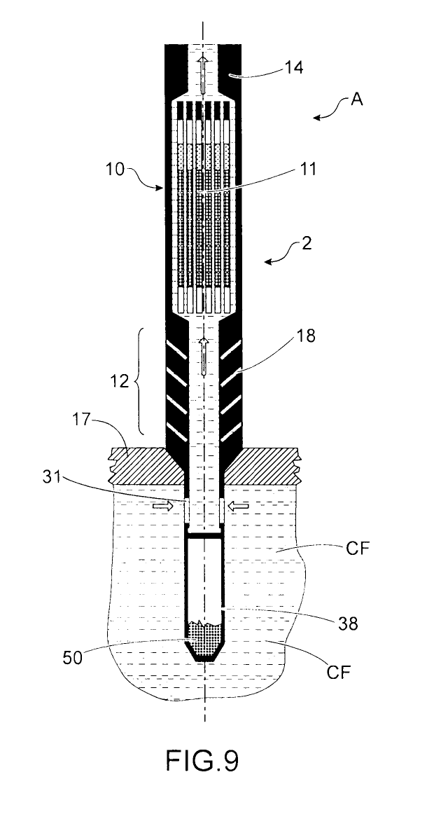

Advantageously, the recuperator is used to confine corium inside the casing; these variant embodiments are shown in FIGS. 7A-7B and 8A-8B.

In FIGS. 7A and 7B, the recuperator 38 forms a non-return valve with the lower end of the housing 40 through which the coolant arrives. The recuperator forms the stopper and the lower end of the housing 40 forms the non-return valve seat.

A spring type elastic means 54 is provided between the bottom of the assembly 16 and the bottom of the recuperator 38 and applies an upwards force on the recuperator 38.

When the recuperator 38 with the neutron absorbing material 50 does not contain corium, it is held in the upper position by the spring 54, at a distance from the lower end of the housing 40.

During normal operation (FIG. 7A), the recuperator 38 is held in the high position, the passage between the casing 2 and the recuperator 38 is open.

During an accident situation when there is degradation of the assembly (FIG. 7B), corium C flows in the recuperator 38, the weight of corium C opposes the load of the spring 54 beyond a given quantity of corium, the recuperator 38 moves downwards, its bottom 42 comes into contact with the lower end of the housing 40 closing the housing 40 against the arrival of coolant. Therefore the corium C is confined in the housing 40, thus protecting the parts of the core that remain intact. Furthermore, this closing is relatively impermeable, which encourages the release of fission products in the inter-assembly zone 20 through the channels 18, enabling faster detection of the accident, as explained above.

In FIGS. 8A and 8B, the recuperator is in normal operation, held in the high position by tabs 52 connecting the upper part of the recuperator to the upper part of the housing 40. These tabs will break under the combined effect of the weight of the corium in the recuperator and their melting in contact with corium. The tabs may be made from a material with a low melting point or from an alloy that has eutectic or peritectic points to facilitate breakage in the presence of corium.

This variant functions in a manner similar to that described in the example embodiment in FIGS. 8A and 8B, and therefore will not be described in detail.

FIG. 9 also shows another example embodiment of an assembly composed of an assembly and a recuperator, in which the recuperator is arranged outside and below the casing, more particularly below the coolant supply and fixed to the assembly.

In FIG. 9, the recuperator 38 is fixed below the casing 2, below the coolant supply windows 31 of the assembly, i.e. below the diagrid 17. The recuperator 38 forms an extension towards the bottom of the assembly 16.

This arrangement of the recuperator outside the casing 2 of the assembly has the advantage that it does not cause any pressure loss inside the casing 2. Furthermore, the recuperator 38 is constantly immersed in the “cold” coolant CF, and therefore this facilitates cooling of the corium after the accident.

The recuperator may contain a neutron absorbing material 50 as in the previous examples, the characteristics applicable to this material and its configuration in the recuperator 38 are also applicable for this recuperator.

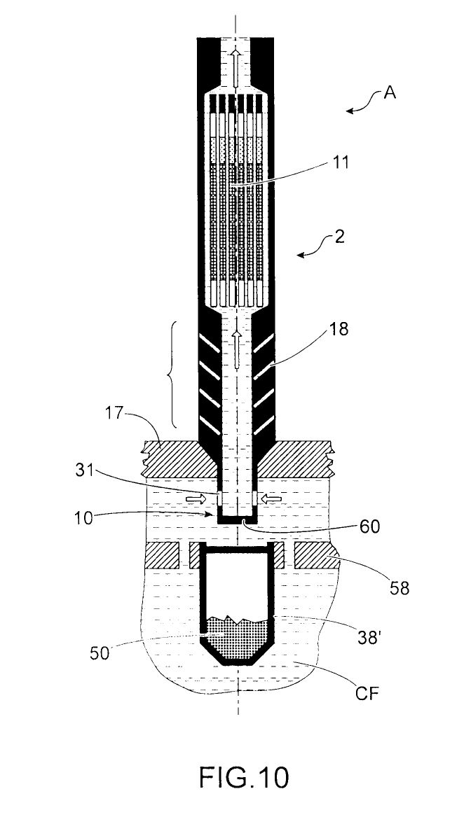

FIG. 10 shows another example embodiment in which the recuperator 38′ is arranged below the stand of the assembly 16, however it is not fixed to it but is supported by a second diagrid 58 arranged below the support diagrid 17 of the assemblies. For example, the second diagrid 58 supports the recuperators 38′ of all assemblies.

In the example shown, the lower longitudinal end of the bottom of the assembly 16 is closed by a plate 60, the coolant entering through the side windows 31. This plate 60 is made to be fusible so that it will not hinder the flow of corium into the recuperator 38′. The plate 60 may advantageously be concave in shape to be able to contain corium debris and thus facilitate melting.

As before, the recuperator 38′ is permanently immersed in the “cold” coolant CC, which helps to cool the corium after the accident.

In this example embodiment, the diameter of the recuperator is not limited by the diameter of the bottom of the assembly, therefore its diameter may be larger, thus making collection of corium more reliable.

Advantageously, the neutron absorbing material 50 could for example be in the form of a bar on the closing plate 60 of the bottom of the assembly 16, and inside the assembly.

The bar then drops into the recuperator with the corium when the plate 60 is detached from the bottom of the assembly 16. This makes it easier to assure that the neutron absorbing material remains efficient throughout the life of the reactor.

In this case, the recuperator is fixed to the second diagrid and remains in position under the core throughout the life of the reactor, between 40 years and 60 years.

If the neutron absorbing material is fixed to the recuperator, it will be necessary to check that its neutron absorbing properties do not vary in time either under the effect of aging or under the effect of ambient radiation in the core. While in the case in which the material is fixed to the assembly, it is easier to evaluate the efficiency of the neutron absorbing material because the assembly is manipulated several times during the life of the reactor (withdrawn, replaced, moved in the core).

The assembly in FIG. 9 also has this advantage because the material can be checked when the assembly is being manipulated, because it is fixed in line with the assembly.

This invention also relates to a reactor comprising at least one assembly according to this invention, advantageously several assemblies arranged adjacent to each other and supported by the diagrid 17. Obviously, the assemblies are not necessarily identical. In particular, they may have different structures and different compositions, for example in terms of the number and type of pins.

The efficiency of the structure of the assemblies according to this invention in mitigating an incident in an assembly to prevent its propagation to other assemblies has been modelled and demonstrated using the SIMMER III calculation software with a sensitivity study, this software is validated and recognised by the Japanese nuclear safety authorities. This model has demonstrated the very good efficiency of this invention in mitigating accidents and facilitating downwards movements of corium.

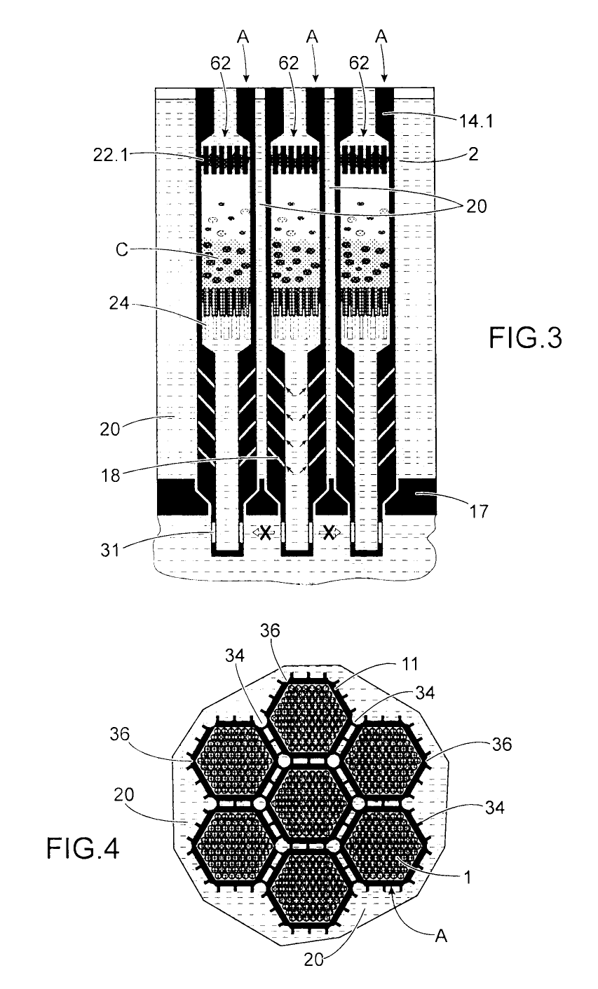

We will now explain operation of an assembly according to this invention with reference to FIGS. 1 and 3.

FIG. 3 shows three assemblies in an accident state.

The assembly A shown in FIG. 1 is in a normal operating state.

The pins 11 are intact, the coolant moves upwards from the bottom through the assembly A inside the casing 2 and evacuates heat emitted by the pins 11.

When an incident occurs (FIG. 3), for example a temperature rise at the pins 11, circulation of the coolant is insufficient to evacuate this excess heat. The part of the cladding at the fissile zone 10 of the pins 11 begins to melt, with the pellets. This melting creates corium C that moves upwards by interaction between the very hot corium and the cold coolant. The upper neutron protection 22.1 of the pins 22 has some thermal inertia and freezes the corium.

An upper plug 62 is then formed at the upper neutron protections 22.1.

The presence of this plug 62 prevents the coolant from leaving the assembly A in the upwards direction. Furthermore, the primary pumps continue to operate, and the coolant pressure in the lower part of the assembly increases. When this pressure exceeds a given threshold, the channels 18 open. The coolant then flows from the inside of the assembly towards the inter-assembly zone 20.

Coolant circulation is restored, the coolant carries fission products with it that will be detected by delayed neutron detection devices.

This circulation also cools the outer surfaces of the casings 2.

The pressure of the coolant in the lower part of the assembly A drops, facilitating downwards movements of the corium C, and corium is no longer entrained towards the top of the assembly.

In the example shown, as the corium C moves downwards, it comes into contact with the fusible lower plenum 24, and therefore this facilitates its melting. Corium continues to move downwards, no element prevents its downwards movement, i.e. there is no element that “freezes” it that can form a lower plug.

The corium C reaches the lower part of the assembly A. If the assembly A comprises a corium recuperator 38 or 38′ as shown in FIGS. 5, 7A to 10, corium will fill the recuperator. In the example embodiments shown in FIGS. 7A to 8B, the recuperator full of corium moves downwards and isolates the corium in the casing 2.

The presence of a neutron absorbing material can prevent any risk of criticality.

Therefore, the corium has been moved away from the fissile zones of adjacent assemblies, and radial propagation of the incident has been avoided due to this invention.

Due to one particularly advantageous embodiment of the invention, the fact of integrating individual corium recuperators into the vessel associated with each of the core assemblies, instead of having one common recuperator for all core assemblies, individualises recuperation of corium.

Therefore, the critical mass is divided. Furthermore, by putting each of these individually recuperated parts of corium in the presence of a neutron absorbing material, the risks of criticality are reduced even further by a dilution mechanism and mixing of the fissile material with the neutron absorbing and/or neutron absorption, which is additional to the critical mass division mechanism.

It has been shown that risks of criticality did exist for some reactors if the fissile mass equivalent to about seven assemblies is concentrated. This order of magnitude depends on the enrichment of the fissile fuel and the mass of fissile fuel contained in a given assembly of the core. By using assemblies provided with individual recuperators according to this invention to these particular reactors, the fissile mass of a recuperator is seven times less than the critical mass.

With the invention, the result obtained is an assembly structure and a reactor core structure capable of mitigating an accident in one or several assemblies, to prevent its radial propagation to the entire core and therefore to eliminate the problem related to secondary power excursions.

The assembly according to this invention is particularly suitable for the construction of sodium-cooled fast breeder nuclear reactors.

1-30. (canceled)

31. A nuclear fuel assembly comprising:
a casing delimiting an inner space divided into a central part as a fissile zone in which a bundle of nuclear fuel pins is located, an upper part, and a lower part;
a lower end comprising a coolant supply inlet;
an upper end comprising a coolant evacuation outlet;
pins in a bundle of pins comprising an upper and/or a lower plenum;
a device creating a communication with the lower part of the inner space of the casing with a zone surrounding the assembly, as an inter-assembly zone, through a wall of the casing, the communication creation device comprising channels passing through the wall for the casing surrounding the lower part and means for closing off channels below a given pressure threshold in the lower part; and
an upper internal neutron protection means arranged inside the casing.

32. A nuclear fuel assembly according to claim 31, in which at least one of the pins does not contain any fertile material at its lower end.

33. A nuclear fuel assembly according to claim 31, in which a lower end of at least one of the pins has a smaller diameter than an outside diameter of other parts of the pin.

34. A nuclear fuel assembly according to claim 31, in which at least a lower end of at least one pin is made of metal with a low melting point, lower than temperature of corium or of a metal alloy for which phase diagram has eutectic or peritectic points at an equivalent temperature lower than the corium temperature.

35. A nuclear fuel assembly according to claim 31, in which at least one of the pins comprises only an upper plenum.

36. A nuclear fuel assembly according to claim 31, in which at least one of the pins does not have any lower neutron protection.

37. A nuclear fuel assembly according to claim 36, in which not all pins comprise a lower neutron protection, and in which the lower neutron protection is integrated into the casing.

38. A nuclear fuel assembly according to claim 37, in which the lower part of the casing has an inside diameter less than the diameter of the fissile zone and a wall of the surrounding casing is thicker than a wall surrounding the fissile zone, thus forming a lower neutron protection.

39. A nuclear fuel assembly according to claim 31, in which the closing means includes rupture disks, exhaust valves, or non-return valves.

40. A nuclear fuel assembly according to claim 31, in which the internal upper neutron protection means is formed by an upper part of the casing comprising an inside diameter smaller than the diameter of the fissile zone and being surrounded by a casing wall thicker than a wall surrounding the fissile zone.

41. A nuclear fuel assembly according to claim 31, in which the internal upper neutron protection means is integrated into the pins and form an upper end of the pins.

42. A nuclear fuel assembly according to claim 31, in which the internal upper neutron protection means is arranged above the pins and in line with the pins.

43. A nuclear fuel assembly according to claim 42, in which a fertile material is fixed to the internal upper neutron protection means and is placed between each pin and the associated internal neutron protection means.

44. A nuclear fuel assembly according to claim 31, in which the casing comprises projections on its outer face that will come into contact with faces of other casings surrounding it to form spacers.

45. A nuclear fuel assembly according to claim 44, in which the projections are arranged approximately at the fissile zone.

46. A nuclear fuel assembly according to claim 31, in which the casing has a polygonal section, external vertices being truncated and/or provided with a groove extending over at least part of a height of the casing.

47. A set of an assembly according to claim 31 and a corium recuperator.

48. A set according to claim 47, in which the corium recuperator is in a form of a jar that will collect corium flowing from inside the casing.

49. A set according to claim 47, in which the corium recuperator fits into a housing in the casing between the coolant supply and the fissile zone.

50. A set according to claim 49, in which cross-section of a passage between an inner face of the recuperator housing and an outer face of the recuperator is approximately equal to cross-section of an assembly coolant supply inlet passage.

51. A set according to claim 49, in which the recuperator can pass from a high position in which the coolant flow passage between a supply inlet and a supply outlet is open, to a low position in which the coolant flow passage between the supply inlet and the supply outlet is closed.

52. A set according to claim 51, in which the corium recuperator is held in the high position by an elastic means.

53. A set according to claim 51, in which the corium recuperator is held in the high position by fusible support tabs.

54. A set according to claim 47, in which the corium recuperator is arranged below the casing.

55. A set according to claim 47, in which the corium recuperator is fixed to the assembly.

56. A set according to claim 54, in which the corium recuperator is supported by a diagrid located below a diagrid supporting the assembly.

57. A set according to claim 47, in which the corium recuperator comprises a neutron absorbing material.

58. A nuclear reactor comprising a plurality of assemblies, at least one of which according to claim 31, arranged adjacent to each other and delimiting inter-assembly zones between them, and coolant circulation pumps in the assemblies.

59. A nuclear reactor comprising a plurality of assemblies, including at least one set according to claim 47 arranged adjacent to each other and delimiting inter-assembly zones between them, and coolant circulation pumps in the assemblies.

60. A nuclear reactor according to claim 58, of liquid sodium-cooled type.

61. A nuclear reactor according to claim 59, of liquid sodium-cooled type.
